(19) United States
(12) Patent Application Publication
(10) Pub. No.: US 2025/0069016 A1
(43) Pub. Date: Feb. 27, 2025

(54) FIELD-SCALE CROP PHENOLOGY MODEL FOR COMPUTING PLANT DEVELOPMENT STAGES

(71) Applicant: BASF CORPORATION, Florham Park, NJ (US)

(72) Inventors: Joseph Martin RUSSO, Bellefonte, PA (US); Jeffrey Wayne GRIMM, Durham, NC (US); Jay Wesley SCHLEGEL, Bellefonte, PA (US); Jeffrey Thomas SPENCER, Bellefonte, PA (US)

(21) Appl. No.: 18/724,452

(22) PCT Filed: Dec. 30, 2022
(86) PCT No.: PCT/US2022/054335

§ 371 Date: Jun. 26, 2024

Related U.S. Application Data
(60) Provisional application No. 63/295,542, filed on Dec. 31, 2021.

(51) Int. Cl. G06Q 10/0637; G06Q 50/02

(52) U.S. Cl. CPC G06Q 10/06375; G06Q 50/02

(57) ABSTRACT

Embodiments of the present disclosure related to systems and methods of a field-scale crop phenology model for simulating/computing plant development stages of a crop. The field-scale crop phenology model is used to simulate plant development stages during a growing season. Knowledge of plant stages, especially as a forecast, helps the timing of chemical applications as well as other crop-dependent management decisions. Together with a user's field location, planting date, and varietal information, the crop phenology model serves as a robust field-scale decision-making tool. In certain embodiments, the phenology model can be run under three different scenarios: historical, preseason, or in-season. Using a blend of different weather data inputs, the phenology model can generate phenology results based on the desired scenario of a user.

### CROSS-REFERENCE TO RELATED APPLICATION(S)

This application claims the benefit of priority of U.S. Provisional Patent Application No. 63/295,542, filed on Dec. 31, 2021, the disclosure of which is hereby incorporated by reference herein in its entirety.

### TECHNICAL FIELD

The present disclosure relates to computational techniques for modeling crop development.

### BACKGROUND

In agriculture it is desirable to maximize the production or yield of a given agricultural product. A number of techniques exist for simulating crop development and yield, which often require several user-specified parameters. Model accuracy can be compromised in situations where user-specified or seed manufacturer-specified parameters are limited. Moreover, models often fail to account for variability in planting conditions as well as changes in underlying assumptions arising from evolving climate and weather patterns.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 illustrates an exemplary system architecture in accordance with embodiments of the present disclosure.

FIG. 2 is a block diagram illustrating an exemplary computer system in accordance with embodiments of the present disclosure.

FIG. 3 is a graphical depiction of a crop phenology model in accordance with embodiments of the present disclosure.

FIG. 4 is a flow diagram illustrating field-level crop phenology modeling in accordance with embodiments of the present disclosure.

FIG. 5 is a plot showing a relationship between 50% cohort corn planting date and winter climate index.

FIG. 6 is a flow diagram illustrating the inputs and outputs of various equations used in the field-level crop phenology model in accordance with embodiments of the present disclosure.

FIG. 7 is a flow diagram illustrating a method for simulating plant development stages in accordance with embodiments of the present disclosure.

### DETAILED DESCRIPTION

Described herein are embodiments of a field-scale crop phenology model for simulating and modeling plant development stages. The field-scale crop phenology model (also referred to herein as the “crop phenology model” or “phenology model”) is used to simulate plant development stages during a growing season. Knowledge of plant stages, especially as a forecast, helps the timing of chemical applications as well as other crop-dependent management decisions. Together with a user's field location, planting date, and varietal information (i.e., one or more crop types), the crop phenology model serves as a robust field-scale decision-making tool. In certain embodiments, the phenology model can be run under three different scenarios: historical, preseason, or in-season. Using a blend of different weather data inputs (historical, forecasted, long-range forecasted, and climatology), the phenology model can generate phenology results based on the desired scenario of a user.

Certain embodiments of the phenology model utilize heat rather than days to simulate plant development and growth during a growing season. A plant has thermal requirements in order to perform its daily physiological processes. These requirements can be defined by air temperature. A plant can survive and function between upper and lower air temperature limits with its optimal growth somewhere between these limits. For each type of crop, there is specific base air temperature above which measurable biomass accumulation is observed during a growing season. Daily average air temperatures are subtracted from this base as a measure of the heat for plant development and growth. The result of this subtraction is referred to as “growing degree days” or “growing degree units.” Daily growing degree days are accumulated over a growing season to track crop development and growth.

In certain embodiments, the phenology model uses climatically-derived accumulated degree days between the planting and harvest stages. Crop growth prior to emergence, however, is a function of soil temperature rather than air temperature. Therefore, the embodiments described herein utilize one or more universal equations with crop type-specific coefficients, which uses soil temperature at seeding depth to better simulate crop germination and emergence. Use of a soil temperature emergence function allows for a more accurate simulation for a given growing season as compared to a degree day accumulation approach alone.

Particularly, emergence may be considered to occur when a tip of the coleoptile has broken through the surface of the medium (e.g., a soil or soil substitute). For example, emergence can be said to occur when the BBCH stage of 09 is reached.

In certain embodiments, adjustments are made to the degree days between both emergence and flowering and flowering and maturity. An adjustment between emergence and flowering accumulated degree days accounts for photoperiod and daylength. This adjustment is particularly important for types of crops that experience dormancy during winter months. An adjustment between flowering and maturity accumulated degree days accounts for equifinality. As used herein, “equifinality” refers to the speeding up (less degree days) of the seed-fill period due to a significant delay in a crop's development by the flowering stage. The derivation of growing degree days and their adjustments are discussed in detail below. Utilization of the dormancy and equifinality adjustments allows for more realistic simulations of the physiological processes associated with plant development.

Certain embodiments utilize a climatological framework. In many countries, there is little or no data on crop varieties and their development characteristics. Therefore, the embodiments herein contemplate a framework that utilizes historical observations of crop growth stages and climatological air temperature records. The framework results in universal functions with crop type-specific coefficients for calculating the dates of key phenological stages based on climatological indices. This allows the degree day requirements for days to maturity to be climatologically determined anywhere in the world. The climatological framework provides an important reference to evaluate the validity of user-provided varietal days to maturity and further allows a determination as to whether a crop is achieving optimal development for a growing season.

The assignment of phenological stages to accumulated degree days is achieved indirectly with a crop growth fraction. The crop growth fraction is calculated by dividing accumulated degree days by the total number of degree days between stages, as is discussed in greater detail below. The crop growth fraction, through its normalization of accumulated degree days to total degree days to maturity, alleviates the need to associate crop phenology schemes (e.g., the BBCH phenological scheme) to growing degree days.

The term “agent” or the like as used in the context of the present disclosure refer to any substance, material or microorganism usable for treating a crop, including but not limited to herbicide, fungicide, insecticide, acaricide, molluscicide, nematicide, rodenticide, repellant, bactericide, biocide, safener, adjuvant, plant growth regulator, fertilizer, urease inhibitor, nitrification inhibitor, denitrification inhibitor, bioherbicide, biofungicide, bioinsecticide, bioacaricide, biomolluscicide, bionematicide, biorodenticide, biorepellant, biobactericide, biological biocide, biological safener, biological adjuvant, biological plant growth regulator, biological urease inhibitor, biological nitrification inhibitor, or biological denitrification inhibitor, or any combination thereof.

### General System Embodiments

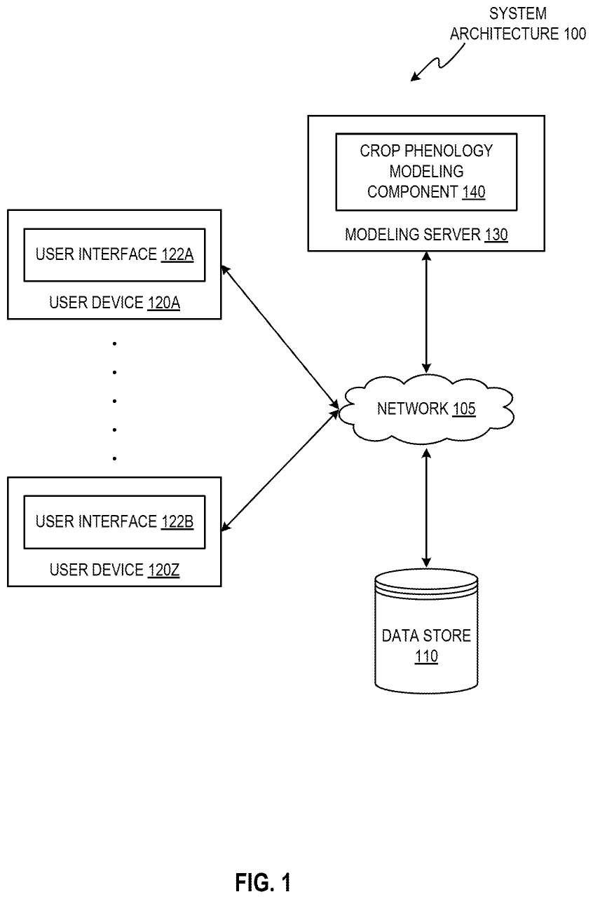

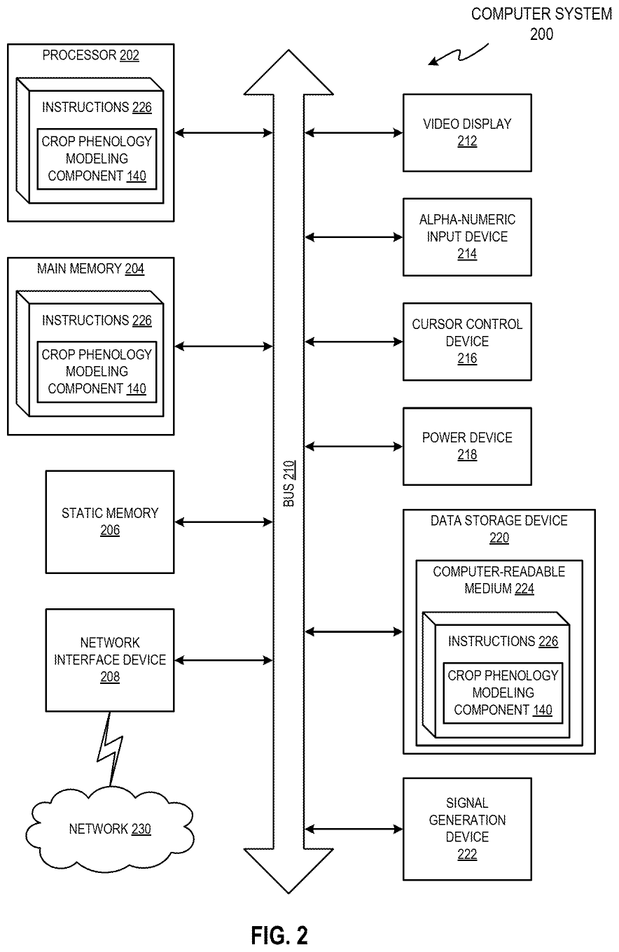

Exemplary implementations of the embodiments described herein are now described. FIG. 1 illustrates an exemplary system architecture 100, in accordance with embodiments of the present disclosure. The system architecture 100 includes a data store 110, user devices 120A-120Z, and a modeling server 130, with each device of the system architecture 100 being communicatively coupled via a network 105. One or more of the devices of the system architecture 100 may be implemented using a generalized computer system 200, described below with respect to FIG. 2. The devices of the system architecture 100 are merely illustrative, and it is to be understood that additional data stores, user devices, modeling servers, and networks may be present.

In one embodiment, network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. Although the network 105 is depicted as a single network, the network 105 may include one or more networks operating as stand-alone networks or in cooperation with each other. The network 105 may utilize one or more protocols of one or more devices to which they are communicatively coupled. The network 105 may translate to or from other protocols to one or more protocols of network devices.

In one embodiment, the data store 110 may include one or more of a short-term memory (e.g., random access memory), a cache, a drive (e.g., a hard drive), a flash drive, a database system, or another type of component or device capable of storing data. The data store 110 may also include multiple storage components (e.g., multiple drives or multiple databases) that may also span multiple computing devices (e.g., multiple server computers). In certain embodiments, the data store 110 may be cloud-based. One or more of the devices of system architecture 100 may utilize their own storage and/or the data store 110 to store public and private data, and the data store 110 may be configured to provide secure storage for private data. In certain embodiments, the data store 110 may be used for data back-up or archival purposes.

The user devices 120A-120Z may include a computing device such as a personal computer (PC), laptop, mobile phone, smart phone, tablet computer, netbook computer, etc. User devices 120A-120Z may also be referred to as a “client device” or “mobile device.” An individual user may be associated with (e.g., own and/or operate) one or more of the user devices 120A-120Z. One or more of the user devices 120A-120Z may also be owned and utilized by different users at different locations. As used herein, a “user” may be represented as a single individual. However, other embodiments of the present disclosure encompass a “user” being an entity controlled by a set of users and/or an automated source. For example, a set of individual users federated as a community in a company or government organization may be considered a “user.”

The user devices 120A-120Z may each utilize one or more local data stores, which may be internal or external devices, and may each include one or more of a short-term memory (e.g., random access memory), a cache, a drive (e.g., a hard drive), a flash drive, a database system, or another type of component or device capable of storing data. The local data stores may also include multiple storage components (e.g., multiple drives or multiple databases) that may also span multiple computing devices (e.g., multiple server computers). In certain embodiments, the local data stores may be used for data back-up or archival purposes.

The user devices 120A-120Z may implement user interfaces 122A-122Z, respectively, which may allow each respective user device to send/receive information to/from other user devices, the data store 110, and the modeling server 130. Each of the user interfaces 122A-122Z may be a graphical user interface (GUI). For example, the user interface 122A may be a web browser interface that can access, retrieve, present, and/or navigate content (e.g., web pages such as Hyper Text Markup Language (HTML) pages) provided by the modeling server 130. In one embodiment, the user interface 122A may be a standalone application (e.g., a mobile “app,” etc.), that enables a user to use the user device 120A to send/receive information to/from other user devices, the data store 110, and the modeling server 130.

In one embodiment, the modeling server 130 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components from which digital contents may be retrieved. In certain embodiments, the modeling server 130 may be a server utilized by any of the user device 120 to retrieve/access content or information pertaining to content. In certain embodiments, additional modeling servers may be present.

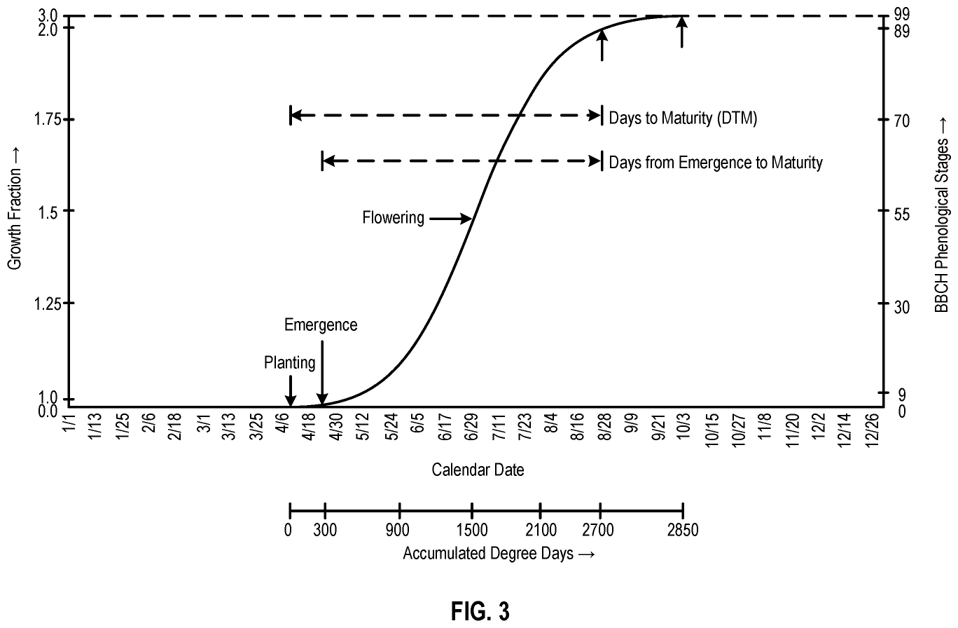

In certain embodiments, the modeling server 130 may implement a crop phenology modeling component 140 to dynamically simulate plant development stages for various crops. The functionality of the crop phenology modeling component 140 is described in greater detail below with respect to FIGS. 3-7.

Although each of the data store 110, the user devices 120A-120Z, and the modeling server 130 are depicted in FIG. 1 as single, disparate components, these components may be implemented together in a single device or networked in various combinations of multiple different devices that operate together. In certain embodiments, some or all of the functionality of the modeling server 130 may be performed by one or more of the user devices 120A-120Z, or other devices that are under control of the modeling server 130.

FIG. 2 illustrates a diagrammatic representation of a machine in the exemplary form of a computer system 200 within which a set of instructions (e.g., for causing the machine to perform any one or more of the methodologies discussed herein) may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 200 may be utilized by or illustrative of any of the devices of the system architecture 100, such as the data store 110, one or more of the user devices 120A-120Z, and the modeling server 130.

The exemplary computer system 200 includes a processing device (processor) 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 220, which communicate with each other via a bus 210.

Processor 202 represents one or more general-purpose processing devices such as a microprocessor, central processing unit, or the like. More particularly, the processor 202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 202 may also be one or more special-purpose processing devices such as an ASIC, a field programmable gate array (FPGA), a digital signal processor (DSP), network processor, or the like. The processor 202 is configured to execute instructions 226 for performing the operations and steps discussed herein.

The computer system 200 may further include a network interface device 208. The computer system 200 also may include a video display unit 212 (e.g., a liquid crystal display (LCD), a cathode ray tube (CRT), or a touch screen), an alphanumeric input device 214 (e.g., a keyboard), a cursor control device 216 (e.g., a mouse), and a signal generation device 222 (e.g., a speaker).

Power device 218 may monitor a power level of a battery used to power the computer system 200 or one or more of its components. The power device 218 may provide one or more interfaces to provide an indication of a power level, a time window remaining prior to shutdown of computer system 200 or one or more of its components, a power consumption rate, an indicator of whether computer system is utilizing an external power source or battery power, and other power related information. In certain embodiments, indications related to the power device 218 may be accessible remotely (e.g., accessible to a remote back-up management module via a network connection). In certain embodiments, a battery utilized by the power device 218 may be an uninterruptable power supply (UPS) local to or remote from computer system 200. In such embodiments, the power device 218 may provide information about a power level of the UPS.

The data storage device 220 may include a computer-readable storage medium 224 on which is stored one or more sets of instructions 226 (e.g., software) embodying any one or more of the methodologies or functions described herein. The instructions 226 may also reside, completely or at least partially, within the main memory 204 and/or within the processor 202 during execution thereof by the computer system 200, the main memory 204 and the processor 202 also constituting computer-readable storage media. The instructions 226 may further be transmitted or received over a network 230 (e.g., the network 105) via the network interface device 208.

In one embodiment, the instructions 226 include instructions for the crop phenology modeling component 140, as described with respect to FIG. 1 and throughout this disclosure. For example, the crop phenology modeling component 140 may be implemented by the modeling server 130 or the user devices 120A-120Z. While the computer-readable storage medium 224 is shown in an exemplary embodiment to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

### Phenology Model

The field-scale crop phenology model (also referred to herein as the “crop phenology model” or “phenology model”) is used to simulate plant development stages during a growing season. Knowledge of plant stages, especially as a forecast, helps the timing of chemical applications as well as other crop development-dependent management decisions. Together with a user's field location, planting date, and varietal information (i.e., one or more crop types), the crop phenology model serves as a robust field-scale decision-making tool. In certain embodiments, the phenology model can be run under three different scenarios: historical, preseason, or in-season. Using a blend of different weather data inputs (historical, forecasted, long-range forecasted, and climatology), the phenology model can generate phenology results based on the desired scenario of a user.

Certain embodiments of the phenology model utilize temperature rather than days after planting to simulate plant development and growth during a growing season. A plant has thermal requirements in order to perform its daily physiological processes. These requirements can be defined by air temperature. A plant can survive and function between upper and lower air temperature limits with its optimal growth somewhere between these limits. For each type of crop, there is specific base air temperature above which measurable biomass accumulation is observed during a growing season. Daily average air temperatures are subtracted from this base as a measure of the heat for plant development and growth. The result of this subtraction is referred to as “growing degree days” or “growing degree units.” Daily growing degree days are accumulated over a growing season to track crop development and growth.

In certain embodiments, the phenology model uses climatically-derived accumulated degree days between the planting and harvest stages. Crop growth prior to emergence, however, is a function of soil temperature rather than air temperature. Therefore, the embodiments described herein utilize one or more universal equations with crop type-specific coefficients, which uses soil temperature at seeding depth to better simulate crop germination and emergence. Use of a soil temperature emergence function allows for a more accurate simulation for a given growing season as compared to a degree day accumulation approach alone.

In certain embodiments, adjustments are made to the degree days between both emergence and flowering and flowering and maturity. An adjustment between emergence and flowering to accumulated degree days accounts for influences of photoperiod and daylength on crop development. This adjustment is particularly important for types of crops that experience dormancy during winter months. An adjustment between flowering and maturity to accumulated degree days accounts for equifinality. As used herein, “equifinality” refers to the speeding up (less degree days) of the seed-fill period due to a significant delay in a crop's development by the flowering stage. The derivation of growing degree days and their adjustments are discussed in detail below. Utilization of the photoperiod and equifinality adjustments allows for more realistic simulations of the physiological processes associated with plant development.

Certain embodiments utilize a climatological framework. In many countries, there is little or no data on crop varieties and their development characteristics. Therefore, the embodiments herein contemplate a framework that utilizes historical observations of crop growth stages and climatological air temperature records. The framework results in universal functions with crop type-specific coefficients for calculating the dates of key phenological stages based on climatological indices. This allows the degree day requirements for days to maturity to be climatologically determined anywhere in the world. The climatological framework provides an important reference to evaluate the validity of user-provided varietal days to maturity and further allows a determination as to whether a crop is achieving optimal development for a growing season.

The assignment of phenological stages to accumulated degree days is achieved indirectly with a crop growth fraction. The crop growth fraction is calculated by dividing accumulated degree days by the total number of degree days between stages, as is discussed in greater detail below. The crop growth fraction, through its normalization of accumulated degree days to total degree days to maturity, alleviates the need to associate crop phenology schemes (e.g., the BBCH phenological scheme) to growing degree days.

### 1. Phenology Model Overview

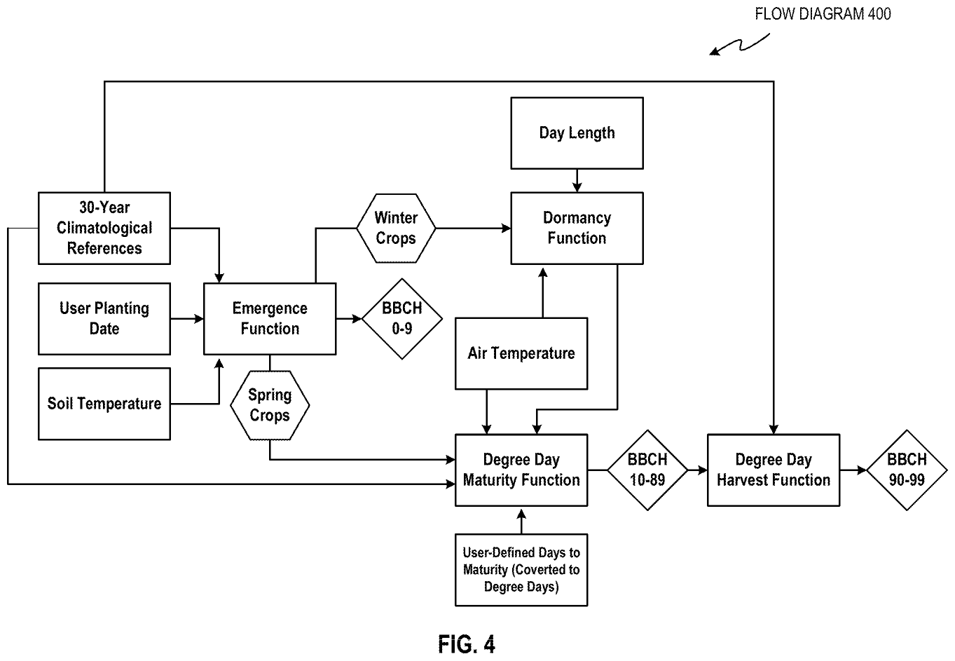

In certain embodiments, the phenology model is a physical deterministic model that dynamically simulates phenological stages of plant growth. The model functions with a series of universal equations that are parameterized by crop type, allowing the model to be quickly scaled by both crop and growing region. In certain embodiments, the model first calculates crop growth fractions. The calculation of crop growth fractions is a unique approach that allows for flexibility in tailoring to different phenological schemes. The period between planting and emergence utilizes a soil temperature model to calculate growth fraction, whereas the period between emergence and maturity utilizes accumulated degree days. Growth fraction, accumulated degree days, and the mapping to the BBCH phenological scheme are discussed in more detail with respect to FIG. 3. FIG. 4 is a flow diagram illustrating a high-level overview of the crop phenology model in accordance with embodiments of the present disclosure.

In certain embodiments, crop growth fraction (CGF) is defined to range from 0.0 to 3.0, and crop growth is divided into three periods: planting to crop emergence (0-1.0), emergence to maturity (1.0-2.0), and maturity to harvest (2.0-3.0). During the period between planting and crop emergence, the crop growth fraction depends on a function tracking the five-day running average of soil temperature at seeding depth. The soil temperature model provides the total numbers of days between planting and emergence. The growth fraction during this period is then determined by using a formula that divides the current number of days from the planting date by the total number of days to reach emergence. In certain embodiments, this fraction dynamically changes as the weather conditions and soil temperature change until the date of emergence is reached.

In certain embodiments, the growth fraction between emergence and maturity is first calculated using the daily seasonal accumulated degree days divided by climatologically-derived total accumulated degree days between the phenological stages defining the period. The crop growth fraction for the period between emergence and maturity is then incrementally increased from 1.0 to 2.0.

An example is now described to demonstrate growth fraction. Based on the data illustrated in FIG. 3, the number of accumulated degree days required between emergence and maturity is 2400 (2700 minus the accumulation between planting and emergence of 300, in this example). Each day of the growing season, the daily degree days are calculated and accumulated. If on the first day following emergence, there are 10 degree days, the growth fraction would be 1.0+10/2400, or 1.0042 (noting that that growth fraction increases from 1.0 to 2.0 between emergence and maturity). If 15 degree days occur the following day, the growth fraction is now 1+25/2400, or 1.0104.

In a similar fashion, the crop growth fraction for the period between maturity and harvest may be calculated using the daily seasonal accumulated degree days divided by the climatologically-derived total accumulated degree days between the phenological stages defining the period. The crop growth fraction for the period between maturity and harvest then incrementally increases from 2.0 to 3.0.

Finally, the phenological stages, as enumerated by BBCH codes for example, are associated with the crop growth fractions. The translation (or mapping) between growth fraction and BBCH is both crop- and region-dependent. An example of mapping BBCH codes to corn growth fractions may be as follows:
BBCH 0 to fraction 0 at planting
BBCH 5 to fraction 0.5 at germination
BBCH 9 to fraction 1.0 at emergence
BBCH 11 to fraction 1.02 at first leaf
BBCH 19 to fraction 1.24 at 9 leaves
BBCH 65 to fraction 1.55 at fully-emerged stigmata
BBCH 73 to fraction 1.66 at early milk
BBCH 89 to fraction 2.0 at black layer (maturity)
BBCH 99 to fraction 3.0 at harvest

While BBCH was chosen as the default crop phenology scale, other phenology scales (e.g., ISU scale) can be easily mapped to the growth fraction as would be understood and appreciated by one of ordinary skill in the art.

FIG. 3 further illustrates the concept of days to maturity (DTM). As used herein, DTM can be defined as the amount of time, in days, that a crop needs to reach maturity from the date of planting, and it indicates the point where the total accumulated degree days between planting and maturity, for a climatically normal season, reaches a variety-specific threshold for maturity. DTM varies as a function of crop type, variety, and growing region, and DTM is typically reported by seed manufacturers. If not reported, DTM can also be derived from historical observations. Utilizing the correct DTM is important for accurate simulation of phenological stages because a DTM determines the accumulated degree day requirements of a crop variety. An incorrect or inaccurate DTM can result in the model simulating crop development too quickly or too slowly, complicating the timing of an application or the planning of other stage-specific field activities during a growing season.

### 2. Climatological Calculations

In certain embodiments, the crop phenology model can be quickly scaled by both crop type and growing region, which can be attributed to underlying climatological backbone. By combining large-scale geographic datasets, relationships can be developed between many years of crop-specific records of planting, emergence, maturity, and harvest and weather data for the same years and scales. An example of such a dataset is the crop statistics dataset provided by the National Agricultural Statistics Service (NASS), within the United States Department of Agriculture. Annual observations of planting, emergence, maturity, and harvest dates for a given crop are published for each state of the United States. They are presented as a range or distribution of dates centered on the most active or “average” dates. The average dates are referred to herein as “50% cohort” dates to acknowledge their position in their respective distributions of actual planting dates. The average dates are used to develop the relationships with weather data. Deutscher Wetterdienst (DWD) provides similar statistics for Germany. It is noted that these climatological calculations are valid for latitudes above 24° north and south of the equator; a different climatological approach is used for the tropics in certain embodiments.

### 2.1 Annual Ratio, Winter Climate Index, and Generic 50% Cohort Function

The relationship between crop phenology and weather data may be defined in two steps. First, two climate indices are developed from historical minimum and maximum air temperature data. These indices may be used to define gradients in climatological environments around the world. The two indices are referred to herein as the “annual ratio” and the “winter climate index.” Using the period between January 1 and December 31, the annual ratio (RATIO) may be calculated as the climatological warmest daily air temperature (TMPXH) in ° C. minus the climatological coldest daily air temperature (TMPNH) in ° C. divided by climatological warmest daily air temperature (TMPXH) in ° C. In certain embodiments, the climatological warmest air temperature and coldest air temperature are derived by harmonically-fitting 30 years of daily maximum and minimum air temperature data, respectively. The annual ratio (RATIO) equation is defined as follows:

$$RATIO = ( TMPXH - TMPNH ) / TMPXH , ° C . \qquad Eq . 1$$

Using the period between October 1 and March 31 in the northern hemisphere, the winter climate index (WCI) may be calculated as the climatological winter daily maximum air temperature (WTMPXH) in ° C. minus the climatological winter daily minimum air temperature (WTMPNH) in ° C. divided by the climatological winter daily maximum air temperature (WTMPXH) in ° C. The climatological winter daily maximum and minimum air temperatures are derived by harmonically-fitting 30 years of daily winter maximum and minimum air temperature data, respectively. For the southern hemisphere, the date range for WCI calculation is April 1 to September 30. The winter climate index (WCI) is defined as follows:

$$WCI = ( WTMPXH - WTMPNH ) / WTMPXH , ° C . \qquad Eq . 2$$

The second step for deriving the relationship between crop phenology data and weather data is to create a function relating the average dates of each observed crop-specific, phenological stage and one of the climate indices. The resulting function is used to determine the date that a crop-specific phenological stage (PSDATE50%) would appear for 50% of fields in each climatological environment defined by one of the indices. In certain embodiments, values for the coefficients (PSDATEA, PSDATEB, PSDATEC, PSDATED) in the function are unique for each crop and phenological stage.

In certain embodiments that utilize the annual ratio (RATIO):

$$PSDATE 50 \% = PSDATEA - PSDATEB / ( 1. + EXP ( PSDATEC * ( PSDATED - RATIO ) ) ) , DOY ; \qquad Eq . 3$$

in certain embodiments that utilize the winter crop index (WCI):

$$PSDATE 50 \% = PSDATEA - PSDATEB / ( 1. + EXP ( PSDATEC * ( PSDATED - WCI ) ) ) , DOY , \qquad Eq . 4$$

where:
PSDATE50% is the average or 50% cohort date of a stage,
PSDATEA is the latest planting date for a stage,
PSDATEB is the difference between latest and earliest planting dates for a stage,
PSDATEC is a unitless scalar determining the slope of the curve for a stage, and
PSDATED is the unitless minimum value for RATIO or WCI.

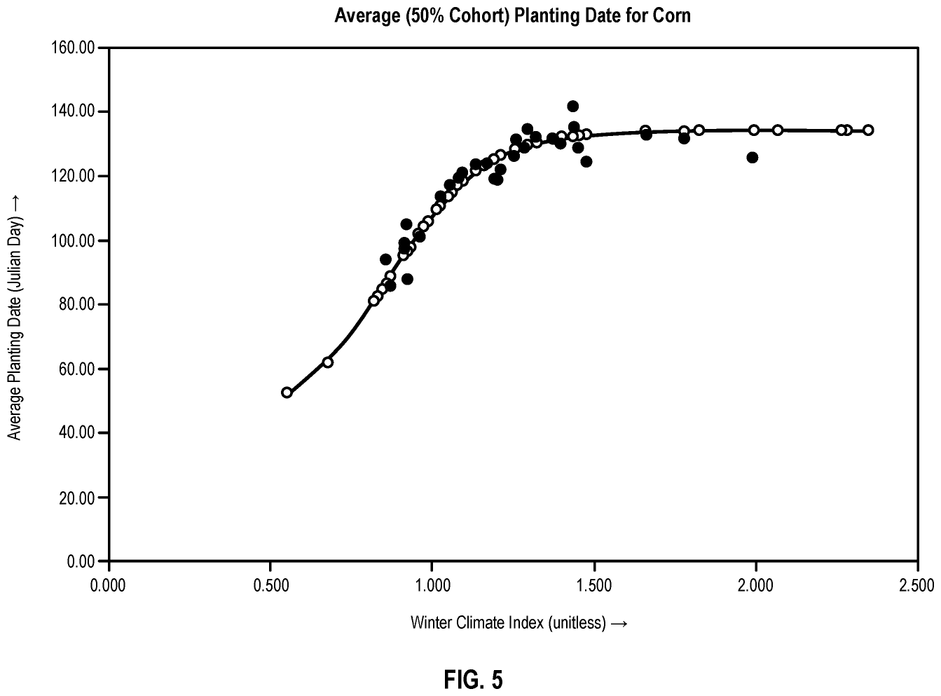

An example of a curve derived from this function is depicted in FIG. 5, which shows a relationship between average or 50% cohort planting date for corn and WCI (the function is depicted as a solid line and observed phenological data is depicted by dots). In certain embodiments, the equations relating the average or 50% cohort date and the RATIO and WCI are the same for all crops types, with the coefficients varying for each crop type.

### 2.2 50% Cohort Planting Date

The following equations calculates day of year (DOY) for the 50% cohort planting date (PLDATE50%) as a function of either RATIO or WCI.

In certain embodiments that utilize RATIO:

$$PLDATE 50 \% = PLDATEA - PLDATEB / ( 1. + EXP ( PLDATEC * ( PLDATED - RATIO ) ) ) , DOY ; \qquad Eq . 5$$

in certain embodiments that utilize WCI:

$$PSDATE 50 \% = PLDATEA - PLDATEB / ( 1. + EXP ( PLDATEC * ( PLDATED - WCI ) ) ) , DOY , \qquad Eq . 6$$

where,
PLDATEA is the latest planting date,
PLDATEB is the difference between latest and earliest planting dates,
PLDATEC is a unitless scalar determining the slope of the curve, and
PLDATED is the unitless minimum value for RATIO or WCI.

The aforementioned parameters, PLDATEA, PLDATEB, PLDATEC, and PLDATED can differ from crop to crop.

### 3. User-Specific Field-Scale Calculations

In certain embodiments, the climatological functions described above play a variety of roles when the crop phenology model is run at different spatial scales and in cases where knowledge of varietal characteristics or planting practices is limited. The role of climatological functions is now discussed for embodiments of a field-scale phenology model for which a full description about a crop variety and planting date is provided.

### 3.1 Terminology

In certain embodiments, to run the crop phenology model at the field-scale, a user (e.g. grower) provides, at the minimum, information about the choice of crop species and variety and planting date(s). A selected variety will have genetically-expressed, physiological characteristics (e.g., maturity rating, disease resistance, standability, drought tolerance, etc.) that may or may not be reported by a seed manufacturer. One such characteristic important for phenological modeling is the days to maturity (DTM), which is the number of days required for a crop to reach maturity after planting. DTM is a measure of the length of a growing season. As such, it is derived in certain embodiments with the assumption that a user will plant a crop in a range of days centered on a typical or average date (as determined from historical planting practices) for a given geographic region.

Since a crop will develop according to seasonal weather conditions and not by calendar days, in certain embodiments DTM is converted into an environmental measure, such as degree days. Adding or accumulating degree days over the period defined by the days to maturity can be interpreted as a measure of the heat available to a crop over a growing season.

Assuming a planting date is known, accumulated degree days for a specific DTM can be derived in certain embodiments from historical weather data. Accumulated degree days can correspond to the addition of daily climatological degree days between the planting date and maturity date as defined by the DTM. The climatological degree days can be derived from the preceding ten years of historical air temperature records. Since calendar dates for the beginning and end of a DTM will change with different user planting dates, the required accumulated degree days over the same number of days may also change. For the same DTM, the number of degree days accumulated from a specific user planting date may differ from the number of degree days accumulated from an average planting date based on historical practices. In other words, a user planting date may differ from the planting dates in the research trials a seed manufacturer conducted to define the DTM for a given variety. Choosing the right variety and planting date is important for maximizing yield potential for a growing season at a location. Planting too early or too late may result in a mismatch to the genetically-expressed environmental requirements of a variety and a reduction in yield potential.

Even if a DTM of a variety is correct for a user's geographic location and planting date, there would potentially be a difference in the simulated and observed dates of a phenological stage during a growing season. Variables other than air temperature can affect development. Management decisions, such as row and plant spacing, seed depth, and the application of growth regulators, can contribute to differences in the seasonal progression of crop phenological stages. Furthermore, since plant development within a field is typically uneven (i.e., different stages occurring on the same date), observational protocol plays a large role in determining a representative stage for an entire field. To account for deviations in the output of the phenology model due to these various factors, certain embodiments may utilize a “biofix” factor to account for potentially significant deviations between simulation and observation. The biofix factor may be a user-entered observation that replaces a simulated phenological stage. In such embodiments, the crop phenology model can ingest a user-entered stage and perform a real-time calibration of the required degree days up to and after the date of an observation. The end result of a calibration is more accurate simulated stages during the remainder of a growing season.

As discussed above, crop growth fraction is defined in certain embodiments to correspond to three periods: planting to emergence (0-1.0), emergence to maturity (1.0-2.0), and maturity to harvest (2.0-3.0). The first period tracks underground plant growth including seed germination, root growth, and up to the emergence of first leaves at the surface. The second period marks both underground root expansion and aboveground plant growth including extending stems and increased foliage, flowering, and fruit set and enlargement. The third period is characterized by a dying plant with drying and falling leaves aboveground and a thinning and shrinking root system underground. Crop development in the first period is primarily a function of heat (soil temperature) and soil moisture (available water in rooting depth). Crop development in the second period is primarily a function of light (incoming solar radiation), heat (air temperature), and soil moisture (available water in rooting depth). Crop development in the third period is a function of heat (air temperature) and canopy moisture (wetting due to precipitation).

Crop development and growth are impacted differentially by below ground and above ground environments during a growing season. Accordingly, in certain embodiments, the simulation of phenological stages utilizes different approaches for each of the three growth fraction periods. In certain embodiments, the first period phenological stages (planting to emergence) are simulated with soil temperature. In certain embodiments, the second period stages (emergence to maturity) are simulated with accumulated degree days. In certain embodiments, the required degree-day accumulation for the second period is the first period degree-day total between planting and emergence subtracted from degree-day total for a DTM between planting and maturity. In certain embodiments, the third period stages (maturity to harvest) are simulated with accumulated degree days derived from historical practices and weather data.

The accumulated degree days in the first period can be estimated using two approaches. In certain embodiments, the first approach utilizes the climatological functions described above. A degree-day accumulation can be calculated for the days between the climatologically-determined 50% cohort planting and emergence dates. The climatological planting to emergence degree days can be subtracted from planting to maturity degree days for a DTM to derive the degree-day accumulation between emergence and maturity (also referred to as the DDMAT).

In certain embodiments, the second approach is to first utilize a user-inputted planting date and run a function based on soil temperature to calculate an emergence date. Next, degree days are calculated between the user-inputted planting date and the calculated emergence date using air temperature data from each of ten historical years (noting that the number of years may vary in different embodiments). Finally, average the calculated degree days between the user planting date and the calculated emergence date over all ten years. Similar to the first approach, the ten-year, average degree-day accumulation between planting and emergence would be subtracted from a planting to maturity degree days for a DTM to derive the DDMAT or degree-day accumulation between emergence and maturity. It is noted that this second approach assumes that the user planting date is within the range of days around the average date used to define a variety's DTM. If a user's planting date is out of range, then the DDMAT could be incorrect resulting in an error in the simulation of phenological dates during a growing season.

### 3.2 User Crop Emergence Date

In certain embodiments, the user emergence date (UEMDATE) is determined by seasonal soil conditions after the user planting date (UPLDATE). The number of days to emergence may be determined by soil temperature at seeding depth and may be calculated with an emergence (EM) function. In certain embodiments, crop emergence refers to the number of days between planting and when the first leaves break through a soil surface. The crop emergence depends on, for example, a five-day running average of soil temperature (5 dST) at seeding depth. The emergence (EM) equation defines the required number of days for emergence based on weather conditions in a current season. The required number of days for emergence will vary year-to-year between a minimum (Min) and maximum (Max) number of days, which will be a function of the following parameters: minimum number of days to emergence; the difference between the minimum and maximum number of days to emergence; a unitless scalar determining the shape of the sigmoid curve; the soil temperature at planting depth; the reference soil temperature corresponding to the maximum number of days to emergence; and a factor to normalize the difference between observed and reference soil temperatures.

Since the five-day running average of soil temperature will change with each successive day after planting, the required number of days for emergence may be dynamically calculated in certain embodiments. A series of days having warmer soil temperatures will reduce the number of days to emergence, while a series of colder soil temperatures will increase the number of days. In certain embodiments, the required number of days to emergence is dynamically calculated every day along with an accumulated number of days from planting. Emergence may be considered to occur on the date when then the post-planting accumulated number of days exceeds or equals the required days determined from the soil temperature emergence (EM) function.

As an example to illustrate the dynamic calculation of days to emergence, suppose that the five-day running average of soil temperature at seeding depth is cold one day after planting. The cold soil temperature results in a calculation of 15 days to emergence. On the fourth day after planting (an accumulation of 4 days), the soil warms and the new calculation for days to emergence is 12 days. On the eighth day after planting (an accumulation 8 days), the soil continues to warm, and the new calculation is 10 days. Over the next two days, there is no further warming in the soil. The accumulated days from planting reaches 10, which matches the required number of days for emergence, and therefore emergence occurs on that date (UEMDATE).

Because the emergence date may be dynamically calculated after planting, the crop growth fraction may also be derived dynamically. In certain embodiments, the crop growth fraction ranges between 0 and 1.0 for the period between planting and emergence and may be calculated as the accumulated days after planting divided by the simulated required number of days for emergence. Since the required number of days will likely change day-to-day, the crop growth fraction will likely change in a non-linear fashion in successive days after planting.

As an example to illustrate the dynamic nature of the crop growth fraction between planting and emergence, the same progression of accumulated days after planting and calculations for days to emergence in the preceding example will be used. The calculation of crop growth fraction is set to 0 on the planting date. With the required days to emergence calculated to be 15 on the first day after planting, the growth fraction is 1/15 or 0.07. With the required days calculated to be 12 on the fourth day after planting, the growth fraction is 4/12 or 0.33. With the required days calculated to be 10 on the eighth day after planting, the growth fraction is 8/10 or 0.8. With the required days calculated to be 10 on the tenth day after planting, the growth fraction is 10/10 or 1.0, indicating the occurrence of emergence. The date of emergence is ten days after the planting date. Table 1 further illustrates this concept.

TABLE 1
Illustrative example of the dynamic nature of the soil
temperature emergence function and growth function

| | Soil | | | Growth |
|---|---|---|---|---|
| | Temperature | EM | GF | Stage |
| Day | (descriptive) | (days) | (unitless) | (BBCH) |
| 0 (UPLDATE) | Cold | 15 | 0.00 | 0—Planting |
| 1 | Cold | 15 | 0.07 | — |
| 2 | Cold | 15 | 0.13 | — |
| 3 | Cold | 15 | 0.20 | — |
| 4 | Warmer | 12 | 0.33 | — |
| 5 | Warmer | 12 | 0.42 | — |
| 6 | Warmer | 12 | 0.50 | —Germination |
| 7 | Warmer | 12 | 0.58 | — |
| 8 | Warmer | 10 | 0.80 | — |
| 9 | Warmer | 10 | 0.90 | — |
| 10 (UEMDATE) | Warmer | 10 | 1.00 | 9—Emergence |

### 3.3 User Crop Maturity Date (Spring Crops)

In certain embodiments, the crop maturity date for spring or winter crops is determined for a given season by adding daily degree days after emergence until the date the accumulation equals or exceeds the varietal requirement defined by the DDMAT. The DDMAT for winter crops may be complicated by a slowdown of growth over the winter months. The adjustment of the DDMAT winter slow growth or “dormancy” will be discussed in greater detail below.

In the case of both spring and winter crops, a user is rarely aware of the DDMAT of a variety since a seed manufacturer typically only publishes the DTM to define the length of a season (planting to maturity) and the emergence date varies significantly year-to-year due to the soil environment. Accordingly, the DDMAT is derived, in certain embodiments, from either historical planting practices or a user reported planting date. Since a user's planting date may be outside the range of dates that were used to determine the DTM from research studies, the historical practices may be chosen as the best approach.

In certain embodiments, the derivation of a user's crop maturity date (UMATDATE) involves three calculations. The first calculation is the accumulated degree days for a user-reported DTM (UDTM). This calculation can be performed after establishing dates for the beginning (planting date) and end (maturity date) of the UDTM. Using the climatological approach, the beginning date is the 50% planting date (PLDATE50%) and the ending date is the date after adding the DTM's days to maturity to the planting date (CMATDATE). The UDTM accumulated degree days then correspond to the addition of climatological daily degree days between the beginning date (PLDATE50%) and the ending date (CMATDATE):

$$UDTM = Σ degree days between CMATDATE and PLDATE 50 \% , degree days . \qquad Eq . 7$$

The second calculation determines the accumulated degree days for the UDDMAT or days form emergence to maturity for the reported user variety. The UDDMAT accumulated degree days is calculated by subtracting accumulated degree days between the climatological planting date (PLDATE50%) and emergence date (EMDATE50%) from the UDTM accumulated degree days:

$$UDDMAT = UDTM - Σ degree days between EMDATE 50 \% and PLDATE 50 \% , degree days . \qquad Eq . 8$$

The UDDMAT represents the required accumulated degree days between emergence and maturity based on a user-reported DTM and the assumption that the variety's planting date followed historical practices.

The third and last calculation for deriving the user maturity date (UMATDATE) is adding to the user emergence date (UEMDATE) the UDDMAT in equivalent days for the period defined by the accumulated degree days:

$$UMATDATE = UEMDATE + UDDMAT ( days ) , DOY . \qquad Eq . 9$$

With the calculation of the user maturity date (UMATDATE), the crop phenology model can provide field scale simulations of phenological stages for any user planting date and DTM in any geography. It is noted that the calculations discussed above apply to spring crops; winter crop development is complicated by dormancy during the winter months and is discussed in greater detail below.

In certain embodiments, daily growth fraction is calculated between emergence date and harvest date by calculating the daily degree day accumulation divided by the UDDMAT. The accumulation of the growth fraction begins at 1.0 (UEMDATE) and ends at 2.0 (UMATDATE). The accumulated growth fraction (AGF) is then mapped to the relevant crop phenology scale (e.g., 9 to 89 for the BBCH scale).

### 3.4 User Crop Maturity Date (Winter Crops)

In certain embodiments, the derivation of the user crop maturity date (UMATDATE) for winter crops is similar to spring crops except for a wintertime period of slowed growth. In higher latitudes, crop development slows during the colder winter months due to both lower temperatures and to reduced daylight. This period of slow growth is referred to herein as “dormancy,” and its length is determined by crop's sensitivity to photoperiod and daylength. In certain embodiments, the crop phenology model accounts for photoperiod sensitivity (R_{P}) and daylength (L_{P}) using a dormancy (DORM) function defined as follows:

$$DORM = 1 - 0.002 * {R}_{P} * {( 20 - {L}_{P} )}^{2} , unitless , \qquad Eq . 10$$

where,
DORM is a unitless scalar,
0.0002 is a coefficient in units of hours⁻²,
R_{P} is the photoperiod sensitivity as a unitless scalar, and
L_{P} is the daylength in units of hours.

DORM accounts for the photoperiod sensitivity and daylength on a crop's rate of development between the phenological stages of emergence and flowering. It can range between 1 (no slowing of development) to 0 (complete pause of development). In certain embodiments, the temperature-derived daily optimum development degree days (DOPT) of a winter crop is multiplied by the daily dormancy function value (DORM) to derive the daily actual development degree days (DACT).

The DACT reflects the slowing of growth of effectively reduced degree days on given day as dictated by a crop's photoperiod sensitivity and daylength at the field location. Less degree days results in the need of more days during the winter months to achieve the same pace of development as a crop not experiencing dormancy. The DACT is defined as follows:

$$DACT = DOPT * DORM , degree days . \qquad Eq . 11$$

In order to calculate the user crop maturity date for a winter crop, the UDDMAT is adjusted in certain embodiments to account for dormancy during a growing season. For spring crops, the UDDMAT is the required accumulated degree days between emergence and maturity dates based on a user DTM and the assumption that the variety's planting date followed historical practices. Without dormancy, the UDDMAT would correspond to the summation of DOPT degree days between user emergence and maturity dates as follows:

$$UDDMAT = Σ DOPT degree days between UEMDATE and UMATDATE , degree days . \qquad Eq . 12$$

With dormancy, the UDDMAT would include two summations in certain embodiments. One summation would be of actual development (DACT) degree days between user emergence and flowering dates and a second summation would be of optimal development (DOCT) degree days between user flowering and maturity dates. The UDDMATD corresponds to the UDDMAT adjusted for dormancy:

$$UDDMATD = Σ DACT degree days between UEMDATE and UFLDATE + Σ DOPT degree days between UFLDATE and UMATDATE , degree days . \qquad Eq . 13$$

With the derivation of UDDMATD, the user crop maturity date (UMATDATE) for a winter crop is computed by adding to the user emergence date (UEMDATE) the UDDMATD in equivalent days for the period defined by the accumulated degree days as follows:

$$UMATDATE = UEMDATE + UDDMATD ( days ) , DOY . \qquad Eq . 14$$

### 3.5 User Crop Maturity Date and Equifinality

The degree days between a user's flowering date and maturity date can be furthered adjusted for equifinality. In certain embodiments, the crop phenology model accounts for equifinality by crediting each day's degree day requirement between flowering and maturity according to the delay in development. In certain embodiments, this credit is achieved in three steps. The first step is the calculation of the remaining degree days (DACC) from the calendar date a crop equals or exceeds a crop growth fraction (CGF) of 1.5 to the climatologically-derived maturity date (MATDATE):

$$DACC = Σ degree days between date of CGF 1.5 and MATDATE , degree days . \qquad Eq . 15$$

The second step is to calculate accumulated degree days (DCLI) between the climatologically-derived date for CGF of 1.5 and maturity date (MATDATE):

$$DCLI = Σ degree days between date of CGF 1.5 and MATDATE , degree days . \qquad Eq . 16$$

In the third step, if DCLI is greater than DACC, then the crop does not have enough predicted degree days to reach maturity due to a significant delay in development at the time of flowering. The ratio of DCLI/DACC is a scalar called the “accelerator” (ACC); its value is constrained to be greater than 1.0. DACC is multiplied by the accelerator ratio to adjust the accumulated degree days (ADACC) between the date of CGF of 1.5 and MATDATE:

$$ADACC = ACC * DACC , degree days . \qquad Eq . 17$$

In certain embodiments, an in-season crop has its daily degree days increased by the accelerator for each day after the date it attains a CGF of 1.5. By crediting the daily degree days, the in-season crop increases or accelerates the accumulation of degrees days until the date of maturity. The speeding up of crop development between a CGF of 1.5 to maturity is termed equifinality.

### 3.6 User Crop Harvest Date

In the case of both spring and winter crops, seed manufacturers rarely published the number of days from maturity to harvest for a specific crop variety (e.g., crop type). The length of the period between maturity and harvest may vary depending on a user's planting date, choice of variety, and prevailing weather conditions during a growing season. Consequently, like the period between planting and emergence, the degree day accumulation for the period between maturity and harvest can be derived climatologically using, for example, ten years of historical average air temperatures. This derivation of degree day accumulation assumes a crop was planted within a range of dates consistent with historical practices at a given location. The climatically-derived accumulated degree days (DDHRV) between the 50% cohort maturity date (MATDATE50%) and 50% cohort harvest date (HRVDATE50%) is as follows:

$$DDHRV = Σ degree days between MATDATE 50 \% and HRVDATE 50 \% , degree days . \qquad Eq . 18$$

The user crop harvest date (UHRVDATE) is calculated by adding the DDHRV in equivalent days for the period defined by the accumulated degree days to the user maturity date (UMATDATE):

$$UHRVDATE = UMATDATE + DDHRV ( days ) , DOY . \qquad Eq . 19$$

In certain embodiments, the daily growth fraction is calculated between the maturity date and the harvest date by calculating the daily degree day accumulation divided by the DDHRV. The accumulation of the growth fraction begins at 2.0 (UMATDATE) and ends at 3.0 (UHRVDATE) and spans the BBCH range of 89 to 99 based on the varietal mapping of the BBCH code to the accumulated growth fraction (AGF).

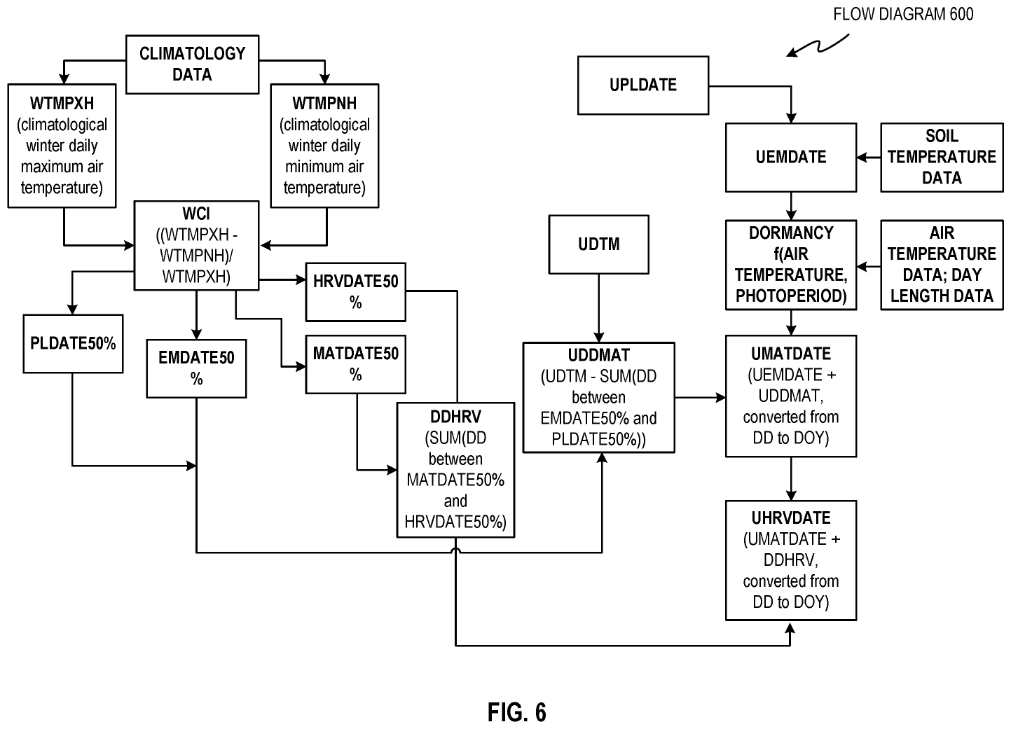

FIG. 6 is a flow diagram 600 illustrating the field-level crop phenology model utilizing the modeling parameters and systems of equations described and defined above to illustrate the various inputs and outputs at each stage of the model.

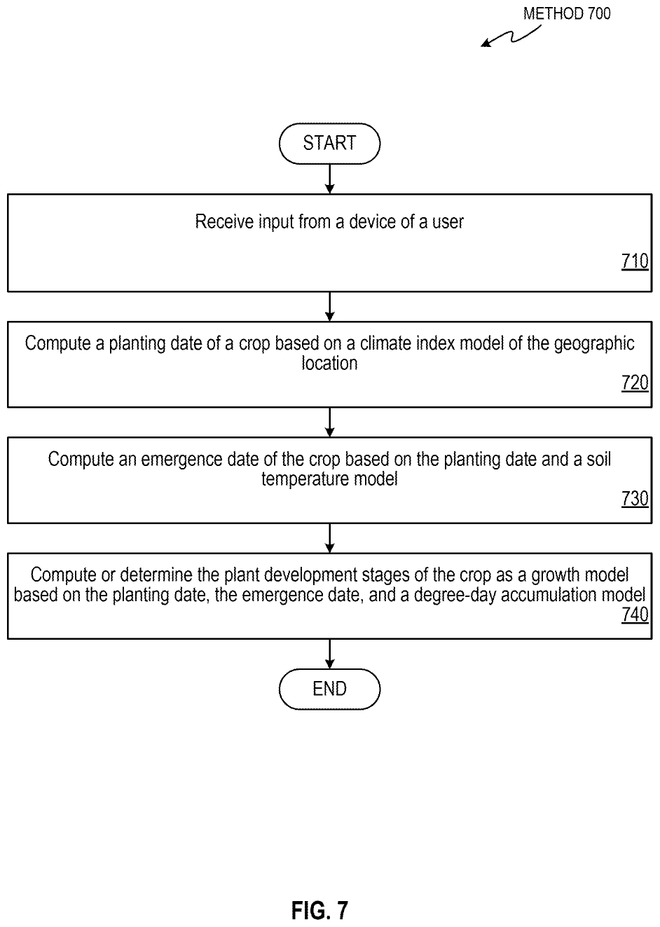

FIG. 7 is a flow diagram illustrating a method 700 for simulating plant development stages in accordance with embodiments of the present disclosure. The method 700 may be performed by processing logic that includes hardware (e.g., circuitry, dedicated logic, programmable logic, microcode, etc.), software (e.g., instructions run on a processing device to perform hardware simulation), or a combination thereof. In certain embodiments, one or more elements of the method 700 may be performed, for example, by a modeling server (e.g., the crop phenology modeling component 140 of the modeling server 130).

At block 710, the processing device (e.g., a processing device of the modeling server 130) receives an input (e.g., via the network 105) from a device of a user (e.g., one or more of the user devices 120A-120Z via their respective user interfaces 122A-122Z). In certain embodiments, the input comprises one or more crop varieties (e.g., identifiers of one or more crop types), and a geographic location for crop(s) to be grown.

In certain embodiments, the input does not specify the planting date of the crop. In other embodiments, the user input specifies an actual planting date or a target planting date. In certain embodiments, the geographic location is specified as a geopolitical location, such as a country, state/region, city, or town. In certain embodiments, the geographic location is specified by ranges of latitude and longitude or global positioning system coordinates. In certain embodiments, the location information is obtained directly from the device (e.g., where the device is located at the time of the input) such that the user need not input the location directly.

At block 720, the processing device computes a planting date of the crop based on either the annual climate index (Eq. 1) or the winter climate index (Eq. 2) value at the specified geographic location. In certain embodiments, the climate index model is generated by modeling historical planting dates for the type of the crop as a function of the climate index.

At block 730, the processing device computes an emergence date based on the planting date and a soil temperature model. In certain embodiments, the processing device simulates soil temperature at the seeding depth for the type of the crop. In certain embodiments, the processing device computes the emergence date by estimating, based on the soil temperature model, a number of days from the planting date of the crop to reach a target growth fraction of the crop representing emergence.

At block 740, the processing device computers/determines (e.g., simulates) the plant development stages of the crop as a growth profile based on the planting date, the emergence date, and a degree-day accumulation model. In certain embodiments, the processing device simulates crop phenological development to maturity using a model of degree day accumulations to determine dates on which phenological stages will be reached at specific location and during a specific growing season. The target number of accumulated degree days is determined based on historical crop maturity data (e.g., which may be retrieved from the data store 110). In certain embodiments, the processing device computes a maturity date of the crop based on the predicted number of days and the emergence date. In certain embodiments, the processing device adjusts growing degree days during winter months to reflect photoperiod sensitivity of winter crops.

In certain embodiments, the processing device transmits the growth profile to the device of the user for display. In certain embodiments, the processing device transmits the growth profile to a separate computing device for additional modeling or to generate a recommendation of an agent to apply to the crop. In certain embodiments, the processing device transmits the growth profile to a device adapted to operate a tool for harvesting or treating the crop.

It is to be understood that the embodiments described herein are not limited to use in any one particular application or environment and that changes may be made to the disclosed implementations without departing from the spirit and scope of the disclosure. Although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring instructions for performing such methods to computing devices. The term “article of manufacture,” as used herein, is intended to encompass a computer program accessible from any computer-readable device or storage media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “configuring,” “receiving,” “converting,” “causing,” “streaming,” “applying,” “masking,” “displaying,” “retrieving,” “transmitting,” “computing,” “generating,” “adding,” “subtracting,” “multiplying,” “dividing,” “selecting,” “parsing,” “optimizing,” “calibrating,” “detecting,” “storing,” “performing,” “analyzing,” “determining,” “enabling,” “identifying,” “modifying,” “transforming,” “aggregating,” “extracting,” “running,” “scheduling,” “simulating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus, device, or system for performing the operations herein. This apparatus, device, or system may be specially constructed for the required purposes, or it may include a general purpose computer selectively activated or reconfigured by a computer program stored in the computer. Such a computer program may be stored in a computer- or machine-readable storage medium, such as, but not limited to, any type of disk including floppy disks, optical disks, compact disk read-only memories (CD-ROMs), and magnetic-optical disks, read-only memories (ROMs), random access memories (RAMs), EPROMS, EEPROMs, magnetic or optical cards, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment” or “one embodiment” means that a particular feature, structure, or characteristic described in connection with the embodiment is included in at least one embodiment. Thus, the appearances of the phrase “an embodiment” or “one embodiment” in various places throughout this specification are not necessarily all referring to the same embodiment. Moreover, it is noted that the “A-Z” notation used in reference to certain elements of the drawings is not intended to be limiting to a particular number of elements. Thus, “A-Z” is to be construed as having one or more of the element present in a particular embodiment.

The present disclosure is not to be limited in scope by the specific embodiments described herein. Indeed, other various embodiments of and modifications to the present disclosure, in addition to those described herein, will be apparent to those of ordinary skill in the art from the description and accompanying drawings. Thus, such other embodiments and modifications are intended to fall within the scope of the present disclosure. Further, while the present disclosure has been described in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

The present invention can also be described by the below Embodiments:

Embodiment 1: A method of simulating plant development stages of a crop, the method comprising:
receiving an input from a device of a user, from a database, or from a sensor, the input comprising a type of the crop and a geographic location for the crop to be grown;
computing a planting date of the crop based on a climate index model of the geographic location;
computing an emergence date for the crop based on the planting date and a soil temperature model;
simulating the plant development stages of the crop as a growth profile based on the planting date, the emergence date, and a degree-day accumulation model; and
transmitting the growth profile to one or more of:
   a device of the user for display;
   a separate computing device for additional modeling or to generate a recommendation of an agent to apply to the crop; or
   a device adapted to operate a tool for harvesting or treating the crop.

Embodiment 2: The method of Embodiment 1, wherein the input does not specify the planting date of the crop.

Embodiment 3: The method of any of Embodiments 1-2, further comprising:
generating the climate index model by modeling historical planting dates for the type of the crop as a function of climate index, wherein climate index is computed based on climatological winter daily maximum air temperature, and climatological winter daily minimum air temperature; and computing a climate index for the geographic location, wherein the planting date of the crop is computed from the climate index model based on the determined climate index.

Embodiment 4: The method of any of Embodiments 1-3, further comprising:
generating the climate index model by modeling historical planting dates for the type of the crop as a function of climate index, wherein climate index is calculated as the climatological winter daily maximum air temperature (WTMPXH) in ° C. minus the climatological winter daily minimum air temperature (WTMPNH) in ° C. divided by the climatological winter daily maximum air temperature (WTMPXH) in ° C., using the winter period between October 1 and March 31 in the northern hemisphere and using the winter period between April 1 to September 30 in the southern hemisphere; and computing a climate index for the geographic location, wherein the planting date of the crop is computed from the climate index model based on the determined climate index.

Embodiment 5: The method of any of Embodiments 1-4, further comprising:
generating the soil temperature model based at least partially on a seeding depth for the type of the crop.

Embodiment 6: The method of any of Embodiments 1-5, wherein computing the emergence date comprises estimating, based on the soil temperature model, a number of days from the planting date of the crop to reach a target growth fraction of the crop.

Embodiment 7: The method of any of Embodiments 1-6, further comprising:
generating the degree-day accumulation model by predicting a number of days required to meet a target number of accumulated degree days between emergence and maturity of the type of the crop based on climatological data associated with the geographic region, wherein the target number of accumulated degree days is determined based on historical crop maturity data; and
computing a maturity date of the crop based on the predicted number of days and the emergence date.

Embodiment 8: The method of Embodiment 7, wherein generating the degree-day accumulation model comprises, responsive to determining that the type of the crop corresponds to a winter crop, accounting for a winter dormancy period.

Embodiment 9: The method of any of Embodiments 1-8, further comprising: using the growth profile at least partially as direct or indirect control parameter to control an agricultural machinery usable for treating the crop.

Embodiment 10: A system for simulating plant development stages of a crop, the system comprising:
a memory device;
a processing device operatively coupled to the memory device, wherein the processing device is configured to perform the method of any of Embodiments 1-9.

Embodiment 11: A non-transitory computer-readable medium having instructions encoded thereon that, when executed by a processing device, cause the processing device to perform the method of any of Embodiments 1-9.

Embodiment 12: A tool for harvesting or treating a crop comprising an on-board processing device configured to perform the method of any of Embodiments 1-9.

1. A method comprising:
receiving an input comprising a type of a crop and a geographic location for the crop to be grown;
computing, by a processing device, a planting date of the crop based on a climate index model of the geographic location;
computing an emergence date for the crop based on the planting date and a soil temperature model;
simulating one or more plant development stages of the crop as a growth profile based on the planting date, the emergence date, and a degree-day accumulation model; and
transmitting the growth profile to one or more of:
a first device of a user;
a computing device adapted to perform one or more of: executing additional modeling or generating a recommendation of an agent to apply to the crop; or
a second device adapted to operate a tool for one or more of harvesting the crop or treating the crop.

2. The method of claim 1, wherein the input does not specify the planting date of the crop.

3. The method of claim 1, further comprising:
generating the climate index model by modeling historical planting dates for the type of the crop as a function of climate index; and
computing, based on climatological winter daily maximum air temperature and climatological winter daily minimum air temperature, the climate index for the geographic location, wherein the planting date of the crop is computed from the climate index model based on the climate index.

4. The method of claim 1, further comprising:
generating the climate index model by modeling historical planting dates for the type of the crop as a function of climate index; and
computing, based on a climatological winter daily maximum air temperature (WTMPXH) in ° C. minus a climatological winter daily minimum air temperature (WTMPNH) in ° C. divided by the climatological winter daily maximum air temperature (WTMPXH) in ° C. using a first period between October 1 and March 31 in a northern hemisphere and using a second period between April 1 to September 30 in a southern hemisphere, the climate index for the geographic location, wherein the planting date of the crop is computed from the climate index model based on the climate index.

5. The method of claim 1, further comprising:
generating the soil temperature model based at least partially on a seeding depth for the type of the crop.

6. The method of claim 1, wherein computing the emergence date comprises estimating, based on the soil temperature model, a number of days from the planting date of the crop to reach a target growth fraction of the crop.

7. The method of claim 1, further comprising:
generating the degree-day accumulation model by predicting a number of days required to meet a target number of accumulated degree days between emergence and maturity of the type of the crop based on climatological data associated with the geographic location, wherein the target number of accumulated degree days is determined based on historical crop maturity data; and
computing a maturity date of the crop based on the number of days and the emergence date.

8. The method of claim 7, wherein generating the degree-day accumulation model comprises, responsive to determining that the type of the crop corresponds to a winter crop, accounting for a winter dormancy period.

9. The method of claim 1, further comprising: using the growth profile at least partially as a direct control parameter or an indirect control parameter to control an agricultural machinery usable to treat the crop.

10. A system comprising:
a memory device to store instructions; and
a processing device operatively coupled to the memory device, wherein the processing device is configured to execute the instructions perform operations comprising:
receiving an input from a device of a user, from a database, or from a sensor, the input comprising a type of a crop and a geographic location for the crop to be grown;
computing a planting date of the crop based on a climate index model of the geographic location;
computing an emergence date for the crop based on the planting date and a soil temperature model;
simulating one or more plant development stages of the crop as a growth profile based on the planting date, the emergence date, and a degree-day accumulation model; and
transmitting the growth profile to one or more of:
a first device of a user for display;
a computing device adapted to perform one or more of: executing additional modeling or generating a recommendation of an agent to apply to the crop; or
a second device adapted to operate a tool for one or more of harvesting the crop or treating the crop.

11. The system of claim 10, wherein the input does not specify the planting date of the crop.

12. The system of claim 10, the operations further comprising:
generating the climate index model by modeling historical planting dates for the type of the crop as a function of climate index; and
computing, based on climatological winter daily maximum air temperature and climatological winter daily minimum air temperature, the climate index for the geographic location, wherein the planting date of the crop is computed from the climate index model based on the climate index.

13. The system of claim 10, the operations further comprising:
generating the climate index model by modeling historical planting dates for the type of the crop as a function of climate index; and
computing, based on a climatological winter daily maximum air temperature (WTMPXH) in ° C. minus a climatological winter daily minimum air temperature (WTMPNH) in ° C. divided by the climatological winter daily maximum air temperature (WTMPXH) in ° C., using a first period between October 1 and March 31 in a northern hemisphere and using a second period between April 1 to September 30 in a southern hemisphere, the climate index for the geographic location, wherein the planting date of the crop is computed from the climate index model based on the climate index.

14. The system of claim 10, the operations further comprising:
generating the soil temperature model based at least partially on a seeding depth for the type of the crop.

15. The system of claim 10, wherein computing the emergence date comprises estimating, based on the soil temperature model, a number of days from the planting date of the crop to reach a target growth fraction of the crop.

16. The system of claim 10, the operations further comprising:
generating the degree-day accumulation model by predicting a number of days required to meet a target number of accumulated degree days between emergence and maturity of the type of the crop based on climatological data associated with the geographic location, wherein the target number of accumulated degree days is determined based on historical crop maturity data; and
computing a maturity date of the crop based on the predicted number of days and the emergence date.

17. The system of claim 16, wherein generating the degree-day accumulation model comprises, responsive to determining that the type of the crop corresponds to a winter crop, accounting for a winter dormancy period.

18. The system of claim 10, the operations further comprising:
using the growth profile at least partially as a direct control parameter or an indirect control parameter to control an agricultural machinery usable to treat the crop.

19. A non-transitory computer-readable medium comprising instructions, which when executed by a processing device, cause the processing device to perform operations comprising:
receiving an input comprising a type of a crop and a geographic location for the crop to be grown;
computing a planting date of the crop based on a climate index model of the geographic location;
computing an emergence date for the crop based on the planting date and a soil temperature model;
simulating one or more plant development stages of the crop as a growth profile based on the planting date, the emergence date, and a degree-day accumulation model; and
transmitting the growth profile to one or more of:
a first device of a user;
a computing device adapted to perform one or more of: executing additional modeling or generating a recommendation of an agent to apply to the crop; or
a second device adapted to operate a tool for one or more of harvesting the crop or treating the crop.

20. The non-transitory computer-readable medium of claim 19, the operations further comprising:
generating the climate index model by modeling historical planting dates for the type of the crop as a function of climate index; and
computing, based on climatological winter daily maximum air temperature and climatological winter daily minimum air temperature, the climate index for the geographic location, wherein the planting date of the crop is computed from the climate index model based on the climate index.
